(19) United States
(12) Patent Application Publication
(10) Pub. No.: US 2009/0219307 A1
(43) Pub. Date: Sep. 3, 2009

(54) LCD DRIVER CIRCUIT

(75) Inventors: Hiroshi Yaguma, Okyo-Ku (JP); Kousuke Itani, Ukyo-Ku (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/345,544

(22) Filed: Dec. 29, 2008

(30) Foreign Application Priority Data
Dec. 28, 2007 (JP) JP2007-341083

(51) Int. Cl. G09G 5/10

(52) U.S. Cl. 345/690

(57) ABSTRACT

A liquid crystal driver performs inversion driving of a plurality of data lines of a liquid crystal panel. A source driver generates a driving voltage in accordance with the brightness data indicating the brightness of a pixel, and supplies the driving voltage to the corresponding data line. A common electrode driver supplies an alternating-current common voltage to a common electrode of the liquid crystal panel. A reference voltage generating circuit includes a plurality of resistors that are connected in series between a power supply terminal and a ground terminal, and generates a plurality of reference voltages that are generated at a plurality of taps disposed at connection points of adjacent resistors. The source driver generates the driving voltage by using any one voltage selected from the plurality of reference voltages. The common electrode driver generates the common voltage by using any one voltage selected from the plurality of reference voltages.

### BACKGROUND OF THE INVENTION

1. Field of the Invention

The present invention relates to a technique of driving a liquid crystal panel, and more particularly to a liquid crystal driver circuit that drives data lines.

2. Description of the Related Art

A liquid crystal panel includes a plurality of data lines, a plurality of scan lines that are disposed to intersect perpendicularly to the data lines, and a plurality of TFTs (Thin Film Transistors) that are arranged in a matrix form at the intersections of the data lines and the scan lines. In order to drive the liquid crystal panel, a gate driver circuit that sequentially selects the plurality of scan lines and a source driver circuit that applies to each data line a voltage according to the brightness are provided.

There is a problem in that the liquid crystal panel will be deteriorated when a direct current voltage is continuously applied to the data lines. In recent years, in order to solve this problem, a method of alternately applying voltages having different polarities in an alternating current manner to each data line (inversion driving method) is prevalent.

In the inversion driving method, when a driving voltage of the first polarity is applied to a data line, a common voltage of the first polarity is applied to a common electrode of the liquid crystal panel, whereas when a driving voltage of the second polarity is applied to a data line, a common voltage of the second polarity is applied to the common electrode.

[Patent Document 1] Japanese Patent Application Laid-open No. H8-320674

[Patent Document 2] Japanese Patent Application Laid-Open No. 2007-286526

The driving voltage corresponding to a certain gradation must be adjusted in accordance with the gamma characteristics of the liquid crystal panel to be driven. Similarly, the level of the common voltage must also be adjusted in accordance with the liquid crystal panel to be driven. A conventional liquid crystal driver is provided with a circuit for adjusting the driving voltage in accordance with the gamma characteristics and a circuit for adjusting the common voltage, thereby raising a problem of increased electric current consumption and increased circuit area.

### SUMMARY OF THE INVENTION

The present invention has been made in view of these problems, and a general purpose thereof is to provide a liquid crystal driver circuit that can reduce the electric current consumption and the circuit area.

In order to solve the aforementioned problems, a liquid crystal driver circuit according to an embodiment of the present invention is a liquid crystal driver circuit that performs inversion driving of a plurality of data lines of a liquid crystal panel, including a source driver circuit that generates a driving voltage in accordance with brightness data indicating brightness of a pixel, and supplies the driving voltage to a corresponding data line; a common electrode driver that supplies an alternating-current common voltage to a common electrode of the liquid crystal panel; and a reference voltage generating circuit that includes a plurality of resistors connected in series between two fixed voltage terminals, and generates a plurality of reference voltages that are generated at a plurality of taps disposed at connection points of the adjacent resistors. The source driver circuit generates the driving voltage by using any one voltage selected from the plurality of reference voltages, and the common electrode driver generates the common voltage by using any one voltage selected from the plurality of reference voltages.

According to this embodiment, the adjustment of the driving voltage and the adjustment of the common voltage are carried out by using the common reference voltage generating circuit, so that the circuit area and the electric current consumption can be reduced.

The common electrode driver may include a center level generating circuit that generates a center level voltage of the common voltage by using a voltage selected from the plurality of reference voltages, and an amplitude generating circuit that generates a switching voltage that swings between two values in synchronization with the inversion driving by using a voltage selected from the plurality of reference voltages, and superposes the switching voltage over the center level voltage.

The common electrode driver may include a driver that outputs a high level and a low level in synchronization with the inversion driving, and a voltage selected from the plurality of reference voltages may be supplied to a power supply terminal on a high electric potential side and a power supply terminal on a low electric potential side of the driver.

A liquid crystal driver circuit according to an embodiment may further include a comparator that compares any one of the plurality of reference voltages with a predetermined threshold voltage, wherein a comparison result may be output as a signal indicating normal operation of the circuit. In this case, it is possible to determine whether the reference voltage is normally generated or not by using the reference voltage generating circuit, so that the circuit area can be further reduced.

The source driver circuit may include a gradation voltage generating circuit that generates voltages of multiple gradations by using the plurality of reference voltages; a plurality of digital-analog converters that are disposed respectively for the plurality of data lines, so as to select and output voltages of the multiple gradations in accordance with the brightness data; and a plurality of source amplifiers that are disposed respectively for the plurality of data lines, so as to supply an output voltage of a corresponding analog-digital converter to a corresponding data line as the driving voltage.

The gradation voltage generating circuit may include a plurality of buffer amplifiers; a plurality of voltage dividing circuits that are disposed respectively for adjacent two buffer amplifiers and have a plurality of subresistors that are disposed in series between output terminals of the two buffer amplifiers and a plurality of taps that are disposed at connection points of the adjacent resistors; and a plurality of selectors that are disposed respectively for the plurality of buffer amplifiers. An output voltage of the buffer amplifier and a voltage of the plurality of taps that are disposed in the plurality of voltage dividing circuits may be output as voltages of the multiple gradations, and the plurality of selectors may respectively receive input of a plurality of the reference voltages that are selected in driving the liquid crystal panel with a positive polarity and a plurality of the reference voltages that are selected in driving the liquid crystal panel with a negative polarity, and each selector may select any one of the reference voltages and output the selected voltage to a corresponding buffer amplifier.

In this case, the multiple gradation voltages can be adjusted with the selectors in accordance with the gamma characteristics of the liquid crystal panel without adjusting the fixed voltage or the resistance value of the reference voltage generating circuit. Namely, the multiple gradation voltages can be adjusted without affecting the common voltage, so that the reference voltage generating circuit can be suitably shared.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram showing a configuration of a liquid crystal display provided with a liquid crystal driver according to an embodiment;

FIG. 2 is a block diagram showing a configuration of a liquid crystal driver according to an embodiment;

FIG. 3 is a view showing a relationship between the gradation (level) indicated by the brightness data and the gradation voltage;

FIG. 4 is a circuit diagram showing a configuration of a gradation voltage generating circuit and a reference voltage generating circuit of FIG. 2; and

FIG. 5 is a circuit diagram showing a configuration of a common electrode driver according to a modification.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, “the state in which a member A is connected to a member B” includes a case in which the member A and the member B are directly physically connected and a case in which the member A and the member B are indirectly connected via another member that does not affect the electric connection state. Similarly, “the state in which a member C is disposed between a member A and a member B” includes a case in which the member A and the member C or, the member B and the member C are directly connected and a state in which they are indirectly connected via another member that does not affect the electric connection state.

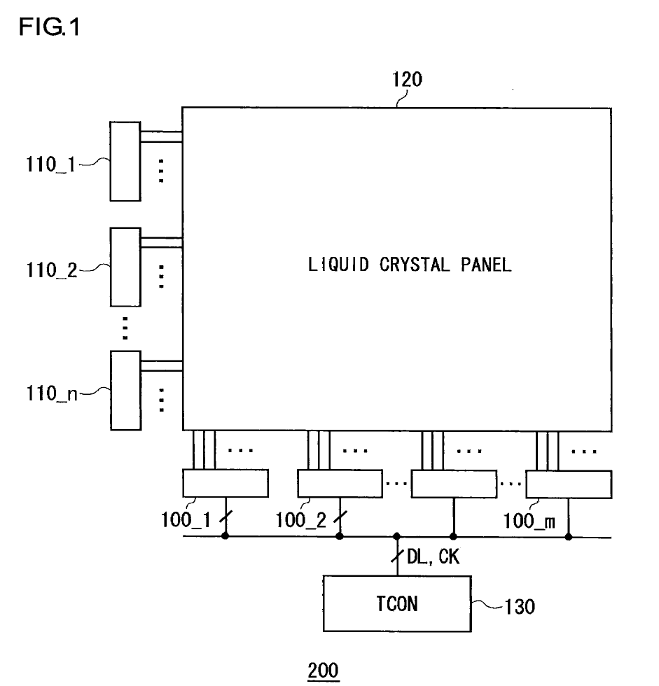

FIG. 1 is a circuit diagram showing a configuration of a liquid crystal display 200 provided with a liquid crystal driver circuit (hereafter referred to as a liquid crystal driver) 100 according to an embodiment. The liquid crystal display 200 includes the liquid crystal driver 100, a gate driver 110, a liquid crystal panel 120, and a timing controller 130.

The liquid crystal panel 120 includes a plurality of data lines and a plurality of scan lines, and pixel circuits are disposed in a matrix form at the intersections of the data lines and the scan lines. The gate driver 110 receives data from the timing controller 130, and sequentially gives voltage to the plurality of scan lines for selection. The liquid crystal driver 100 receives brightness data DL indicating brightness of each pixel that are output from the timing controller 130, together with a clock CK that is in synchronization with the brightness data DL, thereby to drive the plurality of data lines of the liquid crystal panel 120.

Liquid crystal drivers 100_1 to 100_{—}m are arranged along one side of the liquid crystal panel 120. The number m of the liquid crystal drivers 100 is determined in accordance with the resolution of the liquid crystal panel 120. The liquid crystal driver 100 is a functional IC that is integrated on one semiconductor substrate. A plurality of output terminals of the liquid crystal driver 100 are respectively connected to the data lines. Also, the data input terminal of the liquid crystal driver 100 receives input of the brightness data for each pixel from the timing controller 130.

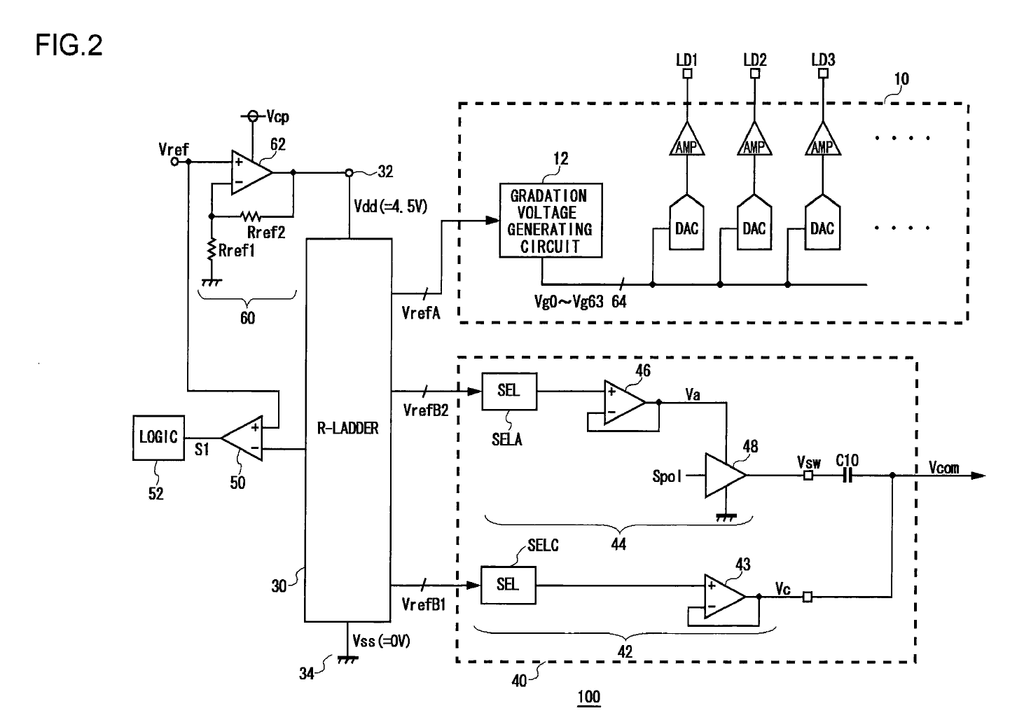

FIG. 2 is a block diagram showing a configuration of a liquid crystal driver 100 according to an embodiment. The liquid crystal driver 100 performs inversion driving of a plurality of data lines of the liquid crystal panel 120. The liquid crystal driver 100 includes a source driver 10, a common electrode driver 40, a reference voltage generating circuit 30, a regulator 60, a comparator 50, and a logic circuit 52, and is a functional IC that is integrated on one semiconductor substrate.

The source driver 10 generates a driving voltage Vd in accordance with the brightness data indicating the brightness of a pixel, and supplies it to the corresponding data line LD.

The common electrode driver 40 supplies an AC common voltage Vcom to the common electrode of the liquid crystal panel 120. In synchronization with the inversion driving, the common voltage Vcom alternately swings between the two values VcomH and VcomL.

The regulator 60 stabilizes a power supply terminal 32 to a reference voltage Vdd. The regulator 60 of FIG. 2 is a linear regulator (three-terminal regulator) including an operation amplifier 62, a first reference resistor Rref1, and a second reference resistor Rref2. The operation amplifier 62 receives a boosted power supply voltage Vcp from a voltage boost circuit such as a charge pumping circuit or a switching regulator that is not illustrated in the drawings. The non-inverting input terminal of the operation amplifier 62 receives input of a reference voltage Vref that is generated by a band gap regulator not illustrated in the drawings.

The regulator 60 stabilizes the electric potential of the power supply terminal 32 to:

Vdd=Vref×(1+Rref2/Rref1).

The reference voltage generating circuit 30 is a ladder resistor network including a plurality of resistors that are connected in series between two fixed voltage terminals (power supply terminal 32 and ground terminal 34). A plurality of taps are provided at the connection points of adjacent resistors inside the reference voltage generating circuit 30, and the voltage generated at each tap is output as the reference voltage.

For example, in the event that Vdd=4.5 V, Vss=0 V, and 100 resistors having an equal resistance value are provided in the reference voltage generating circuit 30, reference voltages Vref1 to Vref449 spaced apart by an interval of 10 mV are output in the range of 0 V to 4.5 V. Some arbitrary ones of the plurality of reference voltages Vref1 to Vref449 are respectively output to the source driver 10, the common electrode driver 40, and the comparator 50.

The source driver 10 generates a driving voltage Vd by using some selected ones (hereafter referred to as a first reference voltage group VrefA) selected from the plurality of reference voltages Vref1 to Vref449.

The common electrode driver 40 generates a common voltage Vcom by using some selected ones (hereafter referred to as a second reference voltage group VrefB) selected from the plurality of reference voltages Vref1 to Vref449.

The comparator 50 compares any one (hereafter referred to as a third reference voltage VrefC) of the plurality of reference voltages Vref1 to Vref449 with a predetermined threshold voltage Vth1. A comparison signal S1 that accords to the comparison result is output as a signal indicating whether the voltage Vdd is normally generated or not, namely, whether the not-illustrated charge pumping circuit and the regulator 60 are normally operating or not. The comparison signal S1 is input into the logic circuit 52 that controls the entire liquid crystal driver 100, and is used for the control of the state of the liquid crystal driver 100, or is output to another processor that is disposed on the outside of the liquid crystal driver 100.

The above is the overall configuration of the liquid crystal driver 100. With this configuration, by suitably setting the first reference voltage group VrefA that is given to the source driver 10, the driving voltage Vd that is to be given to the data lines can be adjusted in accordance with various characteristics such as the gamma characteristics of the liquid crystal panel 120. Also, by suitably setting the second reference voltage group VrefB that is given to the common electrode driver 40, the amplitude and the center value of the common voltage Vcom can be adjusted in accordance with the characteristics of the liquid crystal panel 120.

In other words, with the liquid crystal driver 100 according to the embodiment, the adjustment of the driving voltage Vd and the adjustment of the common voltage Vcom can be carried out with use of the common reference voltage generating circuit 30. As a result, the circuit area and the electric current consumption can be reduced as compared with a case in which the reference voltage generating circuits are separately and individually provided in the source driver 10 and the common electrode driver 40.

In order to compensate for the variation of the resistance value of each resistor contained in the ladder resistor network, a trimming process is carried out. With the liquid crystal driver 100 according to the embodiment, the reference voltage generating circuit 30 is made common, so that the trimming process needs to be carried out only once, thereby reducing the production cost of the liquid crystal driver 100.

Further, in the event that the power supply voltage Vdd fluctuates due to the influence of the noise or the like, the driving voltage Vd and the common voltage Vcom fluctuate in a similar manner, so that the voltage applied to the TFTs within the liquid crystal panel 120 will be constant, thereby enhancing the display quality.

In order to determine whether the voltage-boost circuit that generates a boosted voltage Vcp is normally operating or not, the voltage (the power supply voltage Vdd in FIG. 2) that accords to the raised voltage Vcp must be subjected to voltage division and be compared with the threshold voltage. According to the liquid crystal driver 100 of FIG. 2, the reference voltage generating circuit 30 is used for the voltage division of the power supply voltage Vdd, thereby reducing the circuit area and reducing the trimming process as compared with the case of separately providing a voltage division resistor.

Subsequently, description will be made on a concrete circuit configuration for making the reference voltage generating circuit 30 common with use of the source driver 10 and the common electrode driver 40.

The source driver 10 includes a gradation voltage generating circuit 12, a plurality of digital-analog converters DAC, and a plurality of source amplifiers AMP.

The gradation voltage generating circuit 12 generates voltages of multiple gradations (hereafter referred to as gradation voltages) by using the first reference voltage group VrefA including the plurality of reference voltages from the reference voltage generating circuit 30. In the event that the liquid crystal panel 120 is driven with n bits (n is a natural number), the number of gradations is 2ⁿ. In the following, description will be given on the case of n=8 bits, and it is assumed that the gradation voltage generating circuit 12 generates gradation voltages Vg0 to Vg63.

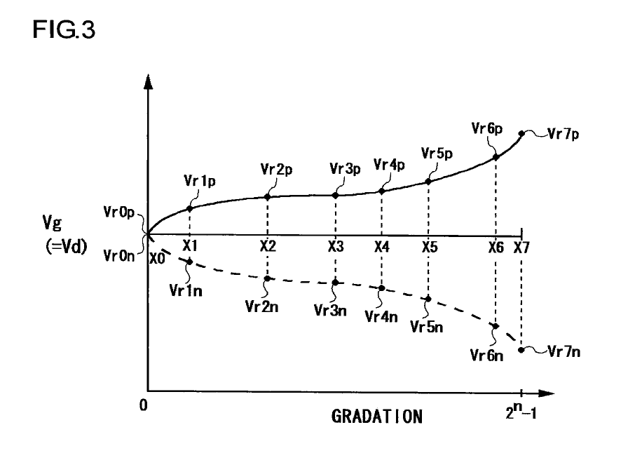

FIG. 3 is a view showing a relationship between the gradation (level) indicated by the brightness data and the gradation voltage Vg. The solid line represents the gradation voltage in the case of the first polarity, and the broken line represents the gradation voltage in the case of the second polarity. The curved line of FIG. 3 is determined in accordance with the gamma characteristics of the liquid crystal panel 120. Namely, the gradation voltage generating circuit 12 generates the plurality of gradation voltages Vg0 to Vg63 so as to go along the curved line of FIG. 3. The gradation voltage Vg corresponding to a certain brightness value assumes different values in the case of the first polarity and in the case of the second polarity.

Returning to FIG. 2, the plurality of digital-analog converters DAC and the plurality of source amplifiers AMP are provided respectively for the plurality of data lines LD. The gradation voltages Vg0 to Vg63 are supplied to each digital-analog converter DAC. Each digital-analog converter DAC receives the digital brightness data indicating the brightness of the pixels on the corresponding data line, and selects and outputs the gradation voltage Vg that accords to the brightness data. Each source amplifier AMP supplies the output voltage Vd of the corresponding digital-analog converter DAC to the corresponding data line LD as a driving voltage Vd.

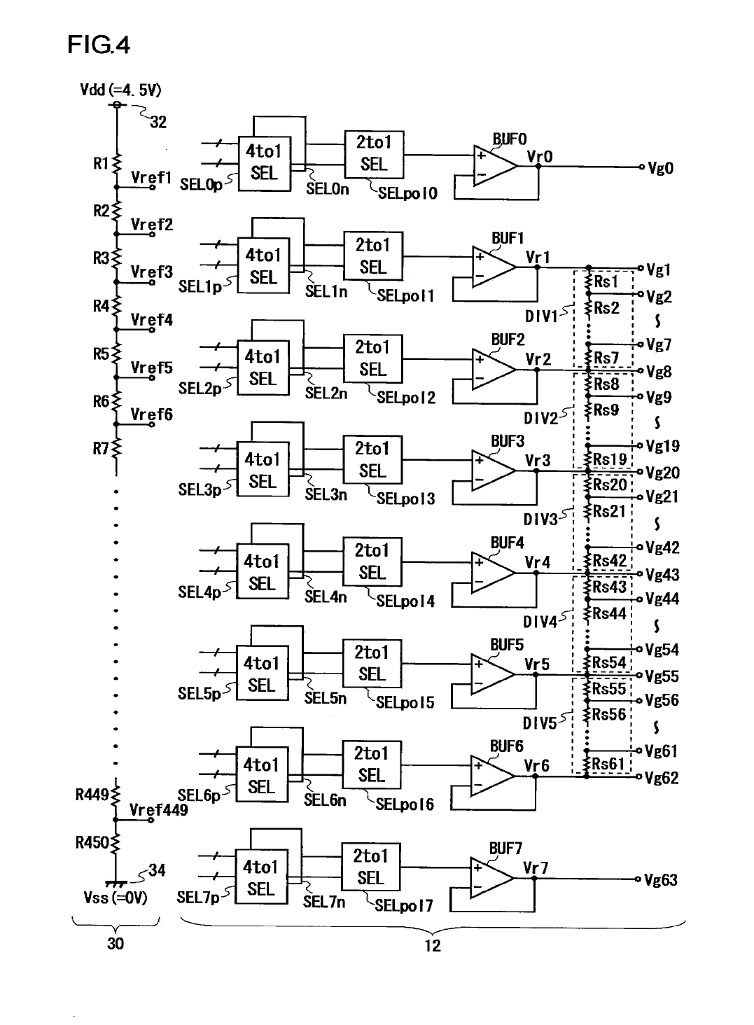

FIG. 4 is a circuit diagram showing a configuration of the gradation voltage generating circuit 12 and the reference voltage generating circuit 30 of FIG. 2. As described above, the reference voltage generating circuit 30 is a ladder resistor network including a plurality of resistors R1 to R450. The reference voltage generating circuit 30 outputs the reference voltages Vref1 to Vref449 from a plurality of taps that are disposed at the connection points of adjacent two resistors.

Before describing the configuration of the gradation voltage generating circuit 12, a method of generating the gradation voltages Vg0 to Vg63 by the gradation voltage generating circuit 12 will be described with reference to FIG. 3. The gradation voltage generating circuit 12 sets a plurality of representative gradation values (hereafter referred to as representative gradation values). For example, among the whole gradations 0 to 63, eight gradations of 0, 1, 8, 20, 43, 55, 62, and 63 are set as representative gradation values X0 to X7. Then, the gradation voltages Vg respectively corresponding to the representative gradation values X0 to X7 are set as a plurality of reference gradation voltages Vr0 to Vr7. For the reference gradation voltages Vr0 to Vr7, the closest ones are selected from among the plurality of reference voltages Vref0 to Vref63 that are generated by the reference voltage generating circuit 30.

The representative gradation values are commonly set for each of the first and second polarities, and the reference gradation voltages Vr0 to Vr7 are individually set for each polarity.

The gradation voltages Vg corresponding to the intermediate gradations of the representative gradation values X0 to X7 are generated by interpolating the reference gradation voltages Vr0 to Vr7. For example, the gradations 2 to 7 are generated by interpolating between the reference gradation voltage Vr1 and the reference gradation voltage Vr2. Preferably, linear interpolation is used.

With this method, a gamma curved line that meets the characteristics of the liquid crystal panel 120 can be realized by setting the representative gradation values and adjusting the reference gradation voltages corresponding to these.

Returning to FIG. 4, a configuration of the gradation voltage generating circuit 12 that can realize the above-described method of generating the gradation voltages will be described.

The gradation voltage generating circuit 12 includes a plurality of buffer amplifiers BUF0 to BUF7, a plurality of voltage dividing circuits DIV1 to DIV5, and selectors SELp0 to SELp7, SELn0 to SELn7, SELpol0 to SELpol7.

The plurality of buffer amplifiers BUF0 to BUF7 are provided in accordance with the number of the above-described representative gradation values. In the event that the number of the representative gradation values is eight, eight buffer amplifiers BUF are provided. The output voltage of the respective buffer amplifiers BUF0 to BUF7 are set to the above-described reference gradation voltages Vr0 to Vr7.

A plurality of voltage dividing circuits DIV1 to DIV5 are provided for every two adjacent buffer amplifiers. The voltage dividing circuits DIV1 to DIV5 are provided for interpolating the intermediate gradations between the representative gradation values. Each of the voltage dividing circuits DIV1 to DIV5 includes a plurality of subresistors Rs. A tap is provided at the connection point of adjacent two subresistors. At each tap, there appears a voltage obtained by voltage division of the two reference gradation voltages Vr that are applied to the two ends of the voltage dividing circuit DIV, and the voltage of each tap is output as the gradation voltage.

The plurality of positive electrode selectors SELp0 to SELp7, the plurality of negative electrode selectors SELn0 to SELn7, and the plurality of polarity selectors SELpol0 to SELpol7 are provided respectively for the plurality of buffer amplifiers BUF0 to BUF7.

The plurality of positive electrode selectors SELp0 to SELp7 and the plurality of negative electrode selectors SELn0 to SELn7 each have a plurality of input terminals. In the circuit diagram of FIG. 4, the selectors are shown as a 4 to 1 selector having four input terminals. A plurality of reference voltages that are used in driving the liquid crystal panel 120 with the positive polarity (first polarity) are input to the plurality of input terminals that are disposed for each of the positive electrode selectors SELp0 to SELp7.

Specifically, the plurality of input terminals of the positive electrode selector SELpi disposed in the i-th buffer amplifier BUFi (i=0 to 7) receive input of a reference voltage that will be a candidate of the reference gradation voltage Vrpi that the buffer amplifier BUFi is to output. The positive electrode selector SELpi selects a suitable one from among these reference voltages, and outputs it as a reference gradation voltage Vrpi.

Similarly, the plurality of input terminals of the negative electrode selector SELni disposed in the i-th buffer amplifier BUFi (i=0 to 7) receive input of a reference voltage that will be a candidate of the reference gradation voltage Vrni that the buffer amplifier BUFi is to output. The negative electrode selector SELni selects a suitable one from among these reference voltages, and outputs it as a reference gradation voltage Vrni.

In synchronization with the inversion driving, the i-th polarity selector SELpoli selects either one of the output voltages of the corresponding positive electrode selector SELpi and negative electrode selector SELni, and outputs it to the buffer amplifier BUFi of a later stage.

The above is the configuration of the gradation voltage generating circuit 12. With this configuration, the above-described plurality of gradation voltages Vg0 to Vg63 can be suitably generated. Also, even if the curve of FIG. 3 is changed in accordance with the characteristics of the liquid crystal panel 120, there is no need to change the reference voltages Vref0 to Vref449 that are generated by the reference voltage generating circuit 30, whereby the correction of the gradation voltage Vg can be prevented from affecting the common electrode driver 40.

Subsequently, a configuration of the common electrode driver 40 will be described. The common electrode driver 40 includes a center level generating circuit 42 and an amplitude generating circuit 44.

The center level generating circuit 42 generates a center level voltage Vc of the common voltage Vcom by using a voltage Vc selected from the second reference voltage group VrefB1 including the plurality of reference voltages coming from the reference voltage generating circuit 30. The center level generating circuit 42 includes a center level setting selector SELC and a buffer amplifier 43. The center level setting selector SELC receives input of the second reference voltage group VrefB1 including the plurality of reference voltages. The center level setting selector SELC selects one voltage from the second reference voltage group VrefB1, and outputs it to the buffer amplifier 43 of a later stage. The buffer amplifier 43 outputs a center level voltage Vc corresponding to the center value of the common voltage Vcom.

The amplitude generating circuit 44 generates a switching voltage Vsw that swings between two values in synchronization with the inversion driving by using a voltage Va selected from the second reference voltage group VrefB2 including the plurality of reference voltages coming from the reference voltage generating circuit 30, and superposes it over the center level voltage Vc. The amplitude generating circuit 44 includes an amplitude setting selector SELA, a buffer amplifier 46, a driver 48, and a coupling capacitor C10.

The amplitude setting selector SELA receives input of the second reference voltage group VrefB2 including the plurality of reference voltages. The amplitude setting selector SELA selects one voltage from the second reference voltage group VrefB2 and outputs it to the buffer amplifier 46 of a later stage. The voltage selected by the amplitude setting selector SELA is supplied to the power supply terminal on the high electric potential side of the driver 48 via the buffer amplifier 46. The power supply terminal on the low electric potential side of the driver 48 is grounded. The input terminal of the driver 48 receives input of the polarity signal Spol that changes between the high level and the low level in synchronization with the inversion driving. The driver 48 outputs a switching voltage Vsw that changes between the high level and the low level in accordance with the polarity signal Spol. The switching voltage Vsw swings between the ground voltage 0 V and the selected voltage Va. In other words, the switching voltage Vsw has an amplitude that accords to the selected voltage Va.

The switching voltage Vsw is superposed over the center level voltage Vc via the coupling capacitor C10. As a result, the center level voltage Vcom is set so that the center value will be Vc and the whole value amplitude will be Va.

With this configuration, the common voltage Vcom can be suitably set in accordance with the liquid crystal panel 120 by selecting a suitable reference voltage Vref with use of the center level setting selector SELC and the amplitude setting selector SELA.

The above embodiment is an exemplification, and it will be understood by those skilled in the art that various modifications can be made on the combination of those constituent elements and treatment processes, and that those modifications are also included within the scope of the present invention. Hereafter, such modifications will be described.

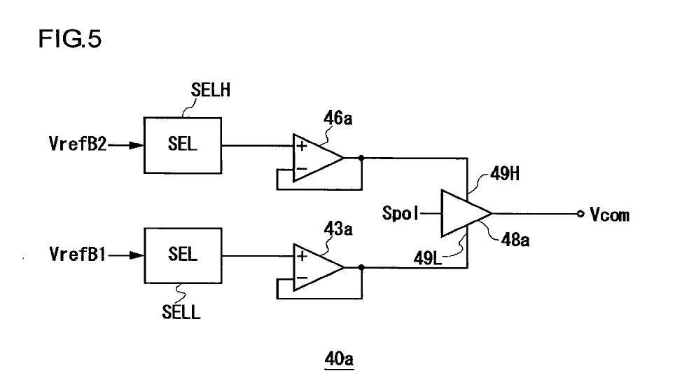

FIG. 5 is a circuit diagram showing a configuration of a common electrode driver 40a according to a modification. The common electrode driver 40a includes a driver 48a, buffer amplifiers 43a, 46a, an upper power supply selector SELH, and a lower power supply selector SELL.

In synchronization with the inversion driving, the driver 48a outputs a high level and a low level. The upper power supply selector SELH outputs any one selected from the plurality of reference voltages Vref, and the buffer amplifier 46a supplies the voltage selected by the upper power supply selector SELH to a power supply terminal 49H on the high electric potential side of the driver 48a. Also, the lower power supply selector SELL outputs any one selected from the plurality of reference voltages Vref, and the buffer amplifier 43a supplies the voltage selected by the lower power supply selector SELL to a power supply terminal 49L on the low electric potential side of the driver 48a.

With this configuration, the electric potentials of high level and low level of the common voltage Vcom can be independently adjusted. Also, there will be no need for the coupling capacitor C10, thereby reducing the number of components.

While the preferred embodiments of the present invention have been described using specific terms, such description is for illustrative purposes only, and it is to be understood that changes and variations may be made without departing from the spirit or scope of the appended claims.

What is claimed is:

1. A liquid crystal driver circuit that performs inversion driving of a plurality of data lines of a liquid crystal panel, comprising:
a source driver circuit that generates a driving voltage in accordance with brightness data indicating brightness of a pixel, and supplies the driving voltage to a corresponding data line;
a common electrode driver that supplies an alternating-current common voltage to a common electrode of the liquid crystal panel; and
a reference voltage generating circuit that includes a plurality of resistors connected in series between two fixed voltage terminals, and generates a plurality of reference voltages that are generated at a plurality of taps disposed at connection points of the adjacent resistors, wherein
the source driver circuit generates the driving voltage by using any one voltage selected from the plurality of reference voltages, and
the common electrode driver generates the common voltage by using any one voltage selected from the plurality of reference voltages.

2. The liquid crystal driver circuit according to claim 1, wherein
the common electrode driver includes:
a center level generating circuit that generates a center level voltage of the common voltage by using a voltage selected from the plurality of reference voltages; and
an amplitude generating circuit that generates a switching voltage that swings between two values in synchronization with the inversion driving by using a voltage selected from the plurality of reference voltages, and superposes the switching voltage over the center level voltage.

3. The liquid crystal driver circuit according to claim 1, wherein
the common electrode driver includes a driver that outputs a high level and a low level in synchronization with the inversion driving, and a voltage selected from the plurality of reference voltages is supplied to a power supply terminal on a high electric potential side and a power supply terminal on a low electric potential side of the driver.

4. The liquid crystal driver circuit according to claim 1, further comprising a comparator that compares any one of the plurality of reference voltages with a predetermined threshold voltage, wherein a comparison result is output as a signal indicating normal operation of the circuit.

5. The liquid crystal driver circuit according to claim 1, wherein
the source driver circuit includes:
a gradation voltage generating circuit that generates voltages of multiple gradations by using the plurality of reference voltages;
a plurality of digital-analog converters that are disposed respectively for the plurality of data lines, so as to select and output voltages of the multiple gradations in accordance with the brightness data; and
a plurality of source amplifiers that are disposed respectively for the plurality of data lines, so as to supply an output voltage of a corresponding analog-digital converter to a corresponding data line as the driving voltage.

6. The liquid crystal driver circuit according to claim 5, wherein
the gradation voltage generating circuit includes:
a plurality of buffer amplifiers;
a plurality of voltage dividing circuits that are disposed respectively for adjacent two buffer amplifiers and have a plurality of subresistors that are disposed in series between output terminals of the two buffer amplifiers and a plurality of taps that are disposed at connection points of the adjacent resistors; and
a plurality of selectors that are disposed respectively for the plurality of buffer amplifiers,
wherein
an output voltage of the buffer amplifier and a voltage of a plurality of taps that are disposed in the plurality of voltage dividing circuits are output as voltages of the multiple gradations, and
the plurality of selectors respectively receive input of a plurality of the reference voltages that are selected in driving the liquid crystal panel with a positive polarity and a plurality of the reference voltages that are selected in driving the liquid crystal panel with a negative polarity, and each selector selects any one of the reference voltages and outputs the selected voltage to a corresponding buffer amplifier.
